(19) United States
(12) Patent Application Publication
(10) Pub. No.: US 2005/0122095 A1
(43) Pub. Date: Jun. 9, 2005

(54) Rotation sensor and method

(76) Inventor: Kevin Allan Dooley, Mississauga (CA)

Correspondence Address: OGILVY RENAULT (PWC), 1981 MCGILL COLLEGE AVENUE, SUITE 1600, MONTREAL, QC, H3A 2Y3, CA

(21) Appl. No.: 10/727,581

(22) Filed: Dec. 5, 2003

(51) Int. Cl. G01P 3/48; G01P 15/08

(52) U.S. Cl. 324/174; 73/514.31; 324/207.21

(57) ABSTRACT

A method and apparatus is disclosed for sensing rotation of a rotating body involving a generating signal in response to a intermittent modification of a magnetic field caused, for example, by a moving of a finite body through the field.

### TECHNICAL FIELD

This invention relates to the field of rotary machines. More precisely, this invention pertains to the field of measuring rotation of such machines.

### BACKGROUND OF THE INVENTION

It is usually desirable to monitor at least the rotational speed of a rotary engine. Such speed may be used for various uses such as control or managing resources.

In the case of a gas turbine engine, such information is critical. Usually it is possible to provide such information using an inductive speed probe and/or a phonic wheel assembly.

Unfortunately, the inductive probe on a turbofan engine is of considerable length so that it can reach the center shaft of the engine while remaining accessible to the outside of the engine for replacement purposes. This inductive probe is therefore costly in terms of manufacturing and maintenance.

Furthermore, it has been contemplated that the rotational speed provided by such inductive probe is not useable at low rotational speeds, for example below 10% of N1 in a gas turbine engine.

There is therefore a need for a method and apparatus that will overcome the above-identified drawbacks.

### SUMMARY OF THE INVENTION

It is an object of the invention to measure a compressor or fan stage rotation in a rotary engine.

Yet another object of the invention is to measure rotation in any suitable rotary system.

According to a first aspect of the invention, there is provided an apparatus for measuring rotational speed of a bladed rotor, comprising a plurality of blades, said bladed rotor encircled by a shroud, the apparatus comprising at least one of said blades, said at least one blade including an electrically conductive material at a location adjacent a tip portion, a permanent magnet supported by the shroud and providing a permanent magnetic field, the magnetic field distributed across a space of sufficient size to extend to intersect said location, a magnetic variation detection unit supported by the shroud and disposed adjacent the permanent magnet at least partially within said space, the unit adapted to provide a signal in response to a variation of said permanent magnetic field, and a processing unit receiving said signal and providing said rotational speed signal.

According to a another aspect of the invention, there is provided an apparatus for measuring at least a rotational speed of a gas turbine bladed rotor having a plurality of blades, the apparatus comprising means for providing a magnetic field, said means mounted to a stationary portion of the engine, means for altering said magnetic field, said means associated with at least one of said blades, said means adapted to pass through and alter said magnetic field as said at least one blade rotates with the rotor, means for detecting an alteration in said magnetic field caused by said altering means and generating a signal in response thereto, and an apparatus adapted to use at least said signal to provide said rotational speed.

According to another aspect of the invention, there is provided an apparatus for measuring rotation of a gas turbine fan having a plurality of blades, the apparatus comprising: at least one magnetic fan blade, a GMR switch, a magnetic circuit and a signal processor, the magnetic circuit including at least permanent magnet and a engine casing assembly, the magnetic circuit extending to a position intersected by said fan blade, the GMR switch positioned to detect a magnetic effect caused by said fan blade passing through said circuit, the GMR switch connected to the signal processor, the signal processor adapted to produce rotation information based at least partially on an input received from the GMR switch.

According to another aspect of the invention, there is provided a method for measuring the rotation of a bladed rotor comprising a plurality of blades, at least one of the blades made at least partially of an electrically conductive material adjacent a tip portion of the blades, comprising, providing a magnetic field adjacent the blade tips in a manner that the rotating blades pass through the field, detecting a variation of the magnetic field caused by a movement of the at least one blades through the magnetic field, detecting a number of said variations, and computing at least one of rotational position, speed and acceleration of said bladed rotor using at least said number of variations.

According to another aspect of the invention, there is provided a method of acquiring information regarding at least one of position, speed and acceleration of a moving body, the method comprising the steps of providing a primary magnetic field, intermittently passing a magnetically-conductive body through the field to thereby induce a secondary magnetic field on the body, sensing an occurrence of the presence of the secondary magnetic field, and using sensed occurrences to determine at least one of body position, speed and acceleration.

The above summary of inventions is not intended to be limiting of the inventions disclosed herein, as inventions may be disclosed which are not described here.

### BRIEF DESCRIPTION OF THE DRAWINGS

Further features and advantages of the present invention will become apparent from the following detailed description, taken in combination with the appended drawings, in which:

FIG. 1 is a partial cross-sectional view of a rotary engine, exemplary of an embodiment of the invention;

FIG. 2A is a further enlarged view of FIG. 1 which shows an embodiment of the invention;

FIG. 2B is an alternate embodiment to the view of FIG. 2A;

FIG. 3 is a flowchart which shows one embodiment of the present method;

FIG. 4 is a flowchart which shows another embodiment of the present method;

FIG. 5 is a somewhat schematic radially outward view of the device of FIG. 2A (i.e. a view directed up the page of FIG. 2A); and

FIG. 6 is a schematic view of the response of one sensor of the present invention in response to a blade-passing event.

It will be noted that throughout the appended drawings, like features are identified by like reference numerals.

### DETAILED DESCRIPTION OF THE PREFERRED EMBODIMENTS

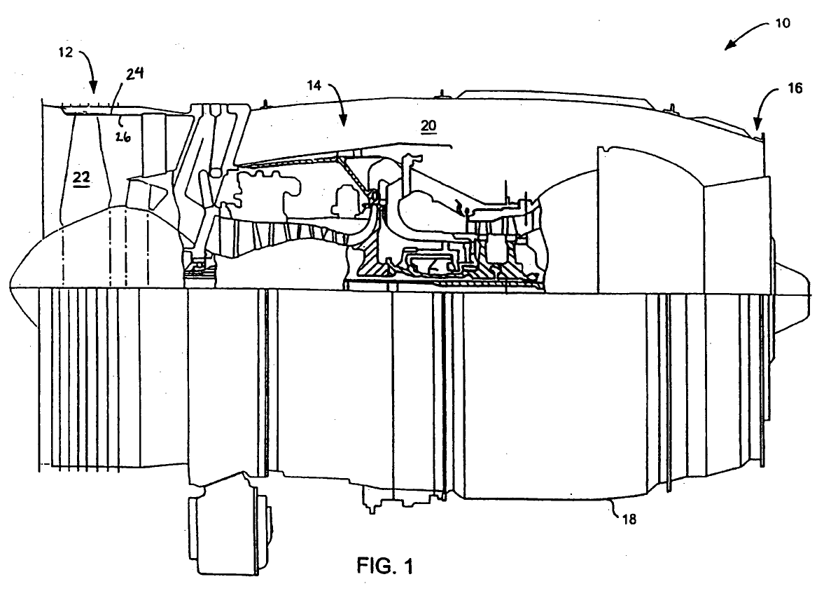

FIG. 1 illustrates a turbofan engine 10, exemplary of an embodiment of the present invention. It will be understood that the present invention may also be applied to all gas turbine engines, as well as other suitable rotational systems.

The turbofan engine 10 comprises, from front to rear, a conventional fan section 12; a conventional core engine section 14, comprising at least one axial compressor, a combustion section, and at least one turbine; and a conventional exhaust section 16, all mounted within a generally cylindrical casing 18. A by-pass duct 20, extends about core engine section 14, within casing 18.

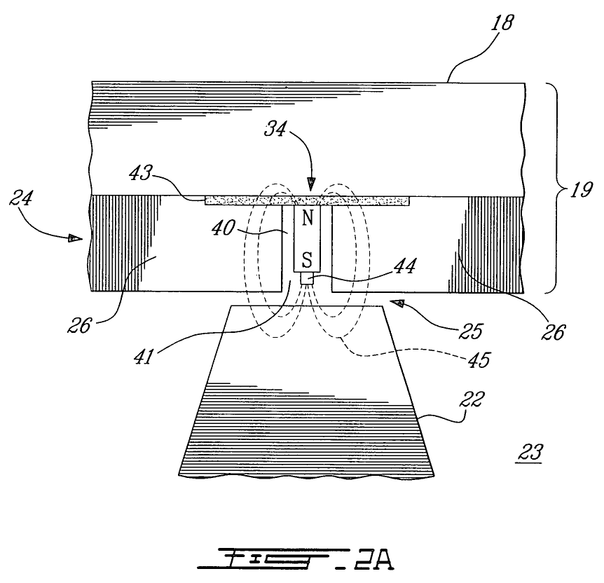

As illustrated, the fan section 12 comprises a rotatable fan blade 22, mounted for axial rotation in direction 23 (into the page in FIG. 2A) about a main central axis of engine 10. A lining 24 comprising a conventional abradable 26 extends circumferentially about the interior of casing 18, between the casing 18 and the tip of fan blade 22. The abradable 26 is made of a conventional material, such as an epoxy potting compound and may be bonded to the interior of casing 18.

The tip of the fan blade 22 extends in close proximity to the abradable 26. A tip clearance 25 or space separates the tip of fan blade 22 from shroud 19. The abradable 26 thus seals the tip of fan blade 22 within casing 18.

FIG. 2A illustrates an enlarged view of a portion of FIG. 1, illustrating an embodiment of the invention and more precisely a shroud 19 and a tip of blade 22. As illustrated, a region of liner 24 is occupied by the abradable 26. The abradable material 26 is preferably a single part, with at least one hole 41 provided therein. The abradable may be installed according to any suitable technique. Within hole 41, an apparatus for measuring rotational speed 34 is secured therein (e.g. by bonding, threaded attachment, etc.). Referring to FIG. 2B, alternately abradable 26 is made up of two portions, a front and aft portion 30 and 32. Mounted between front and aft abradable portions 30 and 32 is an apparatus for measuring rotational speed 34, secured between portions 30 and 32.

As explained below, the apparatus 34 provides a signal indicative rotational movement.

In this embodiment, the apparatus 34 comprises a magnet 40 and a magnetic variation detection unit 44.

The magnet 40 is preferably a permanent magnet made of NdFeB (Neodymium Iron Boron), which material is preferred since it is low cost and has relatively high coercive force. Magnet 40 is also preferably a bar magnet, with North and South poles at the ends, and is mounted such that one of the poles is on the magnetic base and the other is near to the blade tip and gas path, as depicted in FIG. 2A. The elements are preferably sized such that there is a minimum gap between themselves and the blade tips and preferably no gap between the magnet and the casing and/or layer 43, described below.

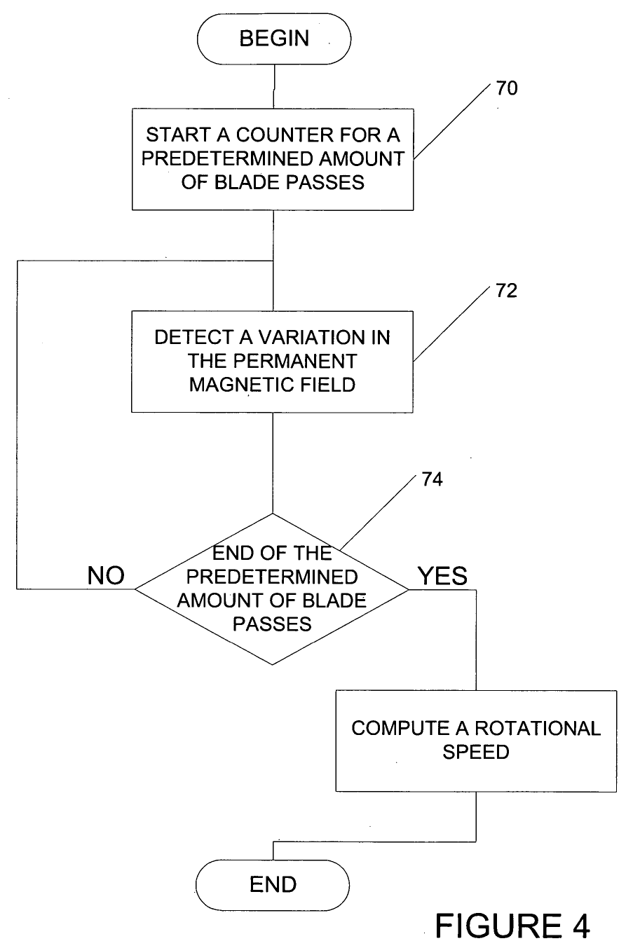

The magnetic variation detection unit 44 is preferably a solid state device sensitive to differential magnetic field. In response to a variation of a magnetic field, the magnetic variation detection unit 44 provides a detected signal. Preferably, the magnetic variation detection unit 44 is selected from ADH00X series of Giant Magneto Resistance (GMR) sensor which is manufactured by NVE Corporation. In exemplary embodiments, NVE sensor numbers AB001-01 or AB001-02 may be used. These sensors are also know as gradiometers or field gradient sensors. Alternately, other magnetic sensors such as AMR-type of Hall-type sensors may be used, however the GMR sensor is preferred because of its sensitivity. GMR sensors which comprise a four arm wheatstone bridge formed from GMR resistors are particularly preferred because they can be excited with an AC source, such that better signal to noise ratio can be obtained in electrically or magnetically noisy environments. The arrangement of the bridge is preferably as shown in FIG. 5, with the blade path or direction 23 being perpendicular to the positioning of GMR resistors GMR2 and GMR4, as discussed further below.

The magnetic variation detection unit 44 is secured to the magnetic variation detection unit 44 preferably with a suitable epoxy. Alternately, as shown in FIG. 2B, a suitable spacer 42 may be provided.

The shroud or casing 18 is preferably a magnetic material (e.g. steel or other alloy), to provide a magnetic flux leakage return path 45 for the unit 44, or if a non-magnetic material is selected for shroud or casing 18, preferably a thin magnetically permeable layer 43 is applied (e.g. by bonding) to the inner surface of the shroud or casing 18, between the inner surface and the abradable 26, to improve the magnetic flux leakage return path 45 between the shroud and the magnet. The layer 43 may of course be used regardless of casing 18 material selected. The layer 43 may be of any size but is preferably sized to capture as much of the magnetic leakage path 45 as desired, and typically this will be approximately at least as wide as the nominal width of the tip of blade 22.

As shown in FIG. 2A, the permanent magnet 40 and the magnetic variation detection unit 44 are disposed in an orientation generally tangential to the circumference of casing 18, and further the magnetic variation detection unit 44 is disposed in the vicinity of the tip of the fan blade 22. The fan blade 22 is preferably made of an electrically conductive material, or has at least a region of conductive material (e.g. integrally provided, or a coating, etc.) near the magnet/sensor location (not every blade need have such material, though it is preferred).

In normal, steady-state, operation fan blade 22 draws air into a compressor section of core engine section 14, of engine 10 (FIG. 1). Similarly, blade 22 draws air through by-pass duct 20, about the main engine section 14. Compressed air exits the compressor section and enters the combustion chamber (not shown) where it is admixed with fuel. The fuel and air mixture is combusted, and exits the rear of the combustion chamber to at least one turbine, coupled to cause fan blade 22 to rotate. Exhaust gases are discharged through exhaust section 16.

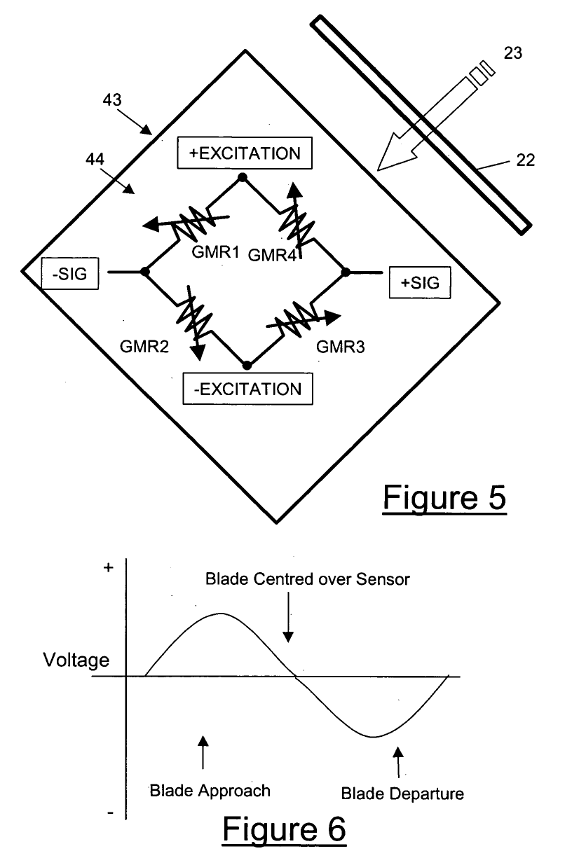

Referring to FIGS. 5 and 6, movement of the tip of the blade 22 in direction 23 in the vicinity of the magnetic field 45 from the permanent magnet creates a local eddy current induced in the blade material. The induced eddy current results in a magnetic field being produced on the moving fan blade 22, as the blades passes through the permanent magnetic field. The permanent magnetic field 45 is therefore altered or opposed and a spatial differential field is created in the space surrounding the fan blade. As the fan blade 22 passes the magnetic variation detection unit 44 the spatial differential magnetic field is detected by the magnetic variation detection unit 44, as follows: as the blade approaches and passes unit 44, the resistance of GMR2 changes, then the resistances of GMR1 and GMR3 change, and then the resistance of GMR4 changes, which results in a signal somewhat like that schematically demonstrated in FIG. 6 (or of opposite polarity, depending on the connections). The magnetic variation detection unit 44 thus provides the signal output.

A processing unit, not shown in FIG. 2A, receives the detected signal output and provides a signal indicative of rotation, such as the rotational speed, of the blade. It will be appreciated by one skilled in the art that signal filtering may be performed by the processing unit when receiving the detected signal.

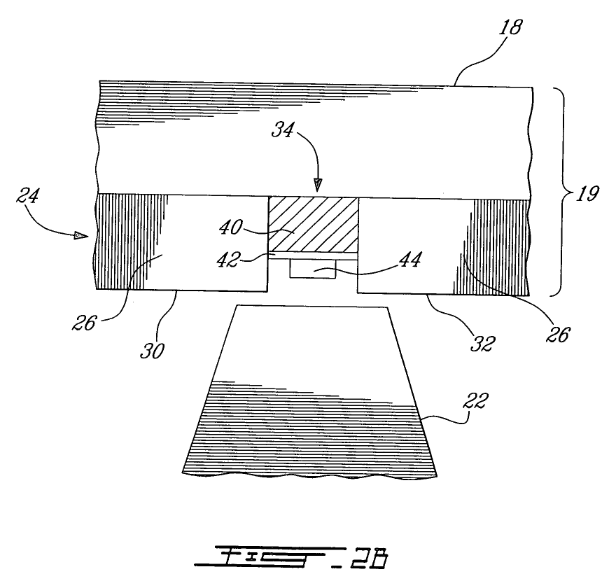

Now referring to FIG. 3, there is shown a flowchart which shows how one method according to the invention operates.

According to step 60, a counter is started by the processing unit for a predetermined amount of time. In this embodiment the predetermined amount of time is fixed, and preferably the time or period is selected based on how often an updated speed is required. With the period fixed, frequency is thus the measured parameter (i.e., the number of blades passing in a fixed period of time). The skilled reader will appreciate that the accuracy of the speed measurement in this approach is affected by the resolution obtained (e.g. number of blade passes in the time period), and because there is only a finite number of blades, and a given period of time to measure them, care must be taken to allow sufficient time to obtain sufficient resolution. The more blade passes occurring, the greater reduction in error. Alternatively, the predetermined amount of time may be variable and the period determined with respect to a pre-determined number of blade passes, as described further below.

According to step 62, a variation in the permanent magnetic field created by the permanent magnet 40 is detected by the magnetic variation detection unit 44. The variation in the permanent magnetic field created by the permanent magnet 40 is generated in response to the movement of the tip of the blade 22 through the magnetic field created by the permanent magnet, resulting in what may be described as a wave of distortion in the magnetic field, which sweeps over the magnetic variation detection unit 44. It is this form of spatial distortion in the magnetic field which is detected by the sensor, and does not change in the overall magnetic field.

According to step 64, a test is performed in order to check whether the given predetermined amount of time is finished. In the case where the given predetermined amount of time is not finished and according to step 62, another variation in the permanent field is detected by the magnetic variation detection unit 44.

In the case where the given predetermined amount of time is finished and according to step 66, a rotational speed is computed.

The rotational speed is computed using a number of variations detected in the permanent field d, a total number of blades 22 in the rotor (N) and the given predetermined amount of time T.

The rotational speed Ω is therefore calculated as follows:

$$Ω = \frac{d}{N \cdot T} .$$

The skilled reader will appreciate that acceleration is the first derivative of speed, and that position can be estimated by counting blades passings, and measuring time therebetween, or integrating speed, etc.

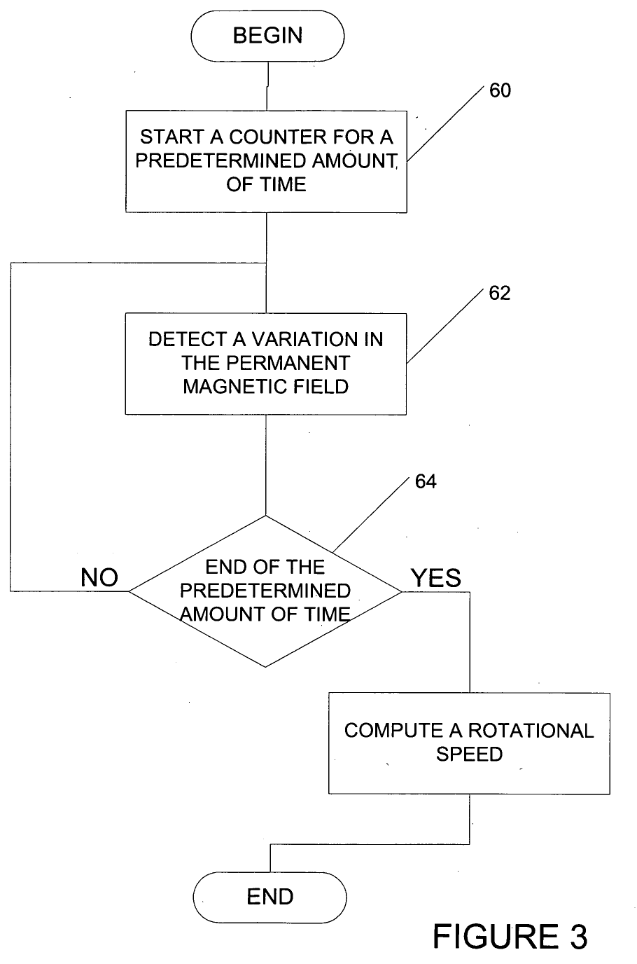

In an alternate system shown in FIG. 4, the period for a given number of blades to pass may be determined (usually at least one full revolution of the rotor). In this approach, the time period varies and a fixed frequency 70 is used to measure the period. The period is preferably selected to correspond to a whole-number multiple of the number of blades on the rotor. The number of blade-passes 72 is then counted 74, and the speed is then calculated 76 from the reciprocal of this period. The advantage of this is a reduction of period measurement error (e.g. due to blade vibrations or slight positional errors, since at least a full rotor period, or a multiple of this period, is thus used in determining the period length. This method advantageously provides faster speed updates as speed increases.

The advantages of the present invention include that it provides an accurate indication while being less intrusive to the structure of the engine than prior art systems, and has relatively few parts, in part because it uses an already-existing functional feature (e.g. the blades) for the dual purpose of rotational measurement.

It will be appreciated that the embodiment of the apparatus for measuring rotational speed 34 is of great advantage as it may be moulded, etc. into the abradable during manufacture. The skilled addressee will appreciate that this is of great advantage for manufacturing and maintenance.

Furthermore, the present apparatus for measuring rotational speed 34 provides a rotational speed that is useable at lower speeds than the prior art.

As mentioned, the skilled reader will appreciate in light of the above teachings that the present invention may also be used to provide relative position information, such as blade position, and when provided with suitable information on initial conditions, etc., may also be useful in determining absolute rotor position. Acceleration information is also determinable, etc. Other useful information may also be obtained.

It will be understood that the present invention is susceptible to modification without departing from its intended scope. For example, the sensor may be placed in any suitable position and orientation relative to the rotating blades which permits the presently described physical phenomenon to occur sufficiently to permit the rotational parameters to be measured. The use of abradable is not required, and when used the abradable may be provided in any suitable configuration. The sensor may be used to measure the rotation of any suitable bladed rotor, however, the sensor also has application beyond gas turbines and bladed rotors, and may be applied to any suitable rotating system which may intermittently interrupt or disturb a magnetic field placed nearby. Though the preferred mode of generating the magnetic filed is through the use of a permanent magnet, the use of other magnetizing means may be possible depending on the application. The relative position of the sensor 44 and the magnet or magnetizing means need not be exactly as shown, but need only work as described.

The embodiments of the invention described above are intended to be exemplary only. The scope of the invention is therefore intended to be limited solely by the scope of the appended claims.

1. An apparatus for measuring rotational speed of a bladed rotor, comprising a plurality of blades, at least one of said blades including an electrically conductive material at a location adjacent a tip portion, said bladed rotor encircled by a shroud, the apparatus comprising:
a permanent magnet supported by the shroud and providing a permanent magnetic field, the magnetic field distributed across a space of sufficient size to extend to intersect said location;
a magnetic variation detection unit supported by the shroud and disposed adjacent the permanent magnet at least partially within said space, the unit adapted to provide a signal in response to a variation of said permanent magnetic field; and
a processing unit receiving said signal and providing said rotational speed.

2. The apparatus as claimed in claim 1, further comprising a spacer located between said permanent magnet and said magnetic variation detection unit.

3. The apparatus as claimed in claim 1, wherein said magnetic variation detection unit comprises a Giant Magneto Resistance (GMR) switch.

4. The apparatus as claimed in claim 1, wherein said magnetic variation detection unit includes at least one Giant Magneto Resistance (GMR) resistor.

5. The apparatus as claimed in claim 3, wherein said Giant magneto Resistance (GMR) switch sits in an abradable surrounding the tip of the plurality of blades.

6. The apparatus as claimed in claim 1, wherein the magnetic variation detection unit is disposed intermediate the permanent magnet and the at least one blade.

7. The apparatus as claimed in claim 1, wherein the at least one of said blades includes substantially all of the plurality of said blades.

8. The apparatus of claim 1, wherein the apparatus is in a gas turbine engine, the bladed rotor is the fan, and the apparatus provides fan speed information for use in operation of the gas turbine engine.

9. An apparatus for measuring at least a rotational speed of a gas turbine bladed rotor having a plurality of blades, the apparatus comprising:
means for providing a magnetic field, said means mounted to a stationary portion of the engine;
means for altering said magnetic field, said means associated with at least one of said blades, said means adapted to pass through and alter said magnetic field as said at least one blade rotates with the rotor;
means for detecting an alteration in said magnetic field and generating a signal in response thereto, said alternation caused by said altering means; and
a device adapted to use at least said signal to provide said rotational speed.

10. An apparatus for measuring rotation of a gas turbine fan having a plurality of blades, the apparatus comprising: at least one magnetic fan blade, a GMR switch, a magnetic circuit and a signal processor, the magnetic circuit including at least a permanent magnet and an engine casing assembly, the magnetic circuit extending to a position intersected by said fan blade, the GMR switch positioned to detect a magnetic effect caused by said fan blade passing through said circuit, the GMR switch connected to the signal processor, the signal processor adapted to produce rotation information based at least partially on an input received from the GMR switch.

11. A method for measuring the rotation of a bladed rotor comprising a plurality of blades, at least one of the blades made at least partially of an electrically conductive material adjacent a tip portion of the blades, the method comprising:
providing a magnetic field adjacent the blade tips in a manner that the rotating blades pass through the field;
detecting a variation of the magnetic field caused by a movement of the at least one blades through the magnetic field;
detecting a number of said variations; and
computing at least one of rotational position, speed and acceleration of said bladed rotor using at least said number of variations.

12. The method as claimed in claim 11, wherein said detecting is performed using a Giant Magneto Resistance (GMR) device.

13. The method as claimed in claim 11, wherein the bladed rotor is a turbofan fan, and the rotational speed of the fan is computed.

14. A method of acquiring information regarding at least one of position, speed and acceleration of a moving body, the method comprising the steps of:
providing a primary magnetic field;
intermittently passing a magnetically-conductive body through the field to thereby induce a secondary magnetic field on the body;
sensing an occurrence of the presence of the secondary magnetic field; and
using sensed occurrences to determine at least one of body position, speed and acceleration.

15. The method as claimed in claim 14, wherein the presence of the secondary magnetic field is sensed by sensing a variation in the primary magnetic field.

16. The method as claimed in claim 14, wherein the secondary magnetic field produces a distortion in the primary magnetic field, and wherein the step of sensing comprises sensing the distortion.

17. The method as claimed in claim 14, wherein the presence of the secondary magnetic field is sensed by sensing a spatial differential magnetic field surrounding the body, a spatial differential magnetic field.
